(19) United States
(12) Patent Application Publication
(10) Pub. No.: US 2023/0395001 A1
(43) Pub. Date: Dec. 7, 2023

(54) LIGHT GUIDE PLATE WITH METALLIZED PIXELS FOR LIGHT EXTRACTION IN SOLAR SIGNS

(71) Applicant: NanoPath, Inc., Leominster, MA (US)

(72) Inventor: Kevin Donahue, Harvard, MA (US)

(21) Appl. No.: 18/205,414

(22) Filed: Jun. 2, 2023

Related U.S. Application Data
(60) Provisional application No. 63/348,586, filed on Jun. 3, 2022.

(51) Int. Cl. G09F 13/18; F21V 8/00; G09F 13/16

(52) U.S. Cl. CPC G09F 13/18; G02B 6/0035; G02B 6/0065; G09F 13/16; G09F 2013/1854

(57) ABSTRACT

Light guides for solar-powered signs are disclosed. The light guide can include a sheet of at least partially transparent material configured to transmit light. The light guide can include a plurality of light-extraction features formed on a surface of the sheet. Each light-extraction feature of the plurality of light-extraction features can include a reflective mirror layer deposited on a surface of the light-extraction feature. The solar-powered sign can include the light guide, a diffusion film coupled to the light guide, and a solar panel coupled to the light guide that captures light passing through the diffusion film and the light guide.

### CROSS-REFERENCES TO RELATED APPLICATIONS

This application claims the benefit of and priority to U.S. Provisional Patent Application No. 63/348,586, filed Jun. 3, 2022, the content of which is incorporated herein by reference in its entirety for all purposes.

### BACKGROUND

Light guides are physical structures that can guide optical electromagnetic waves. Light guides can include optical fiber waveguides, transparent dielectric waveguides made of plastic and glass, liquid light guides. It is challenging to guide light in a manner that reduces interference from other sources of electromagnetic waves.

### SUMMARY

The present techniques relate to edge-lit light guide plates with metalized pixels for light extraction. The light guides described herein allow for external light to pass through the plate, which may be advantageous, for example, to collect solar energy with a solar panel in a solar sign. The present techniques provide edge-lit light guides that can perform light extraction using metallized mirror pixels, which compensate for the loss of light extraction efficiency due to effects of external light transmission.

At least one aspect of the present disclosure is directed to a light guide. The light guide can include a sheet of at least partially transparent material configured to transmit light. The light guide can include one or more light-extraction features formed on a surface of the sheet. Each light-extraction feature of the plurality of light-extraction features includes a reflective mirror layer deposited on a surface of the light-extraction feature.

In some implementations, the plurality of light-extraction features is deposited in a predetermined pattern across the surface of the sheet. In some implementations, the predetermined pattern is generated using a pseudorandom sampling algorithm. In some implementations, the plurality of light-extraction features is deposited on the sheet using an inkjet printing process. In some implementations, the plurality of light-extraction features comprises a white ink.

In some implementations, the light guide includes a cutout on an edge of the sheet. In some implementations, the light guide includes a light source positioned within the cutout. In some implementations, the light source is configured to inject light into the edge of the sheet to illuminate the surface of the light guide via the plurality of light-extraction features. In some implementations, the sheet comprises a polycarbonate material or an acrylic material.

In some implementations, the plurality of light-extraction features are configured to receive light from an edge of the sheet, and reflect the light to illuminate a diffusion film coupled to a second surface of the light guide. In some implementations, the sheet comprises a region of a predetermined size that does not include the plurality of light-extraction features.

At least one other aspect of the present disclosure is directed to a light-extraction pixel. The light-extraction pixel can include a first layer of a reflective ink material having a first surface configured to couple to a light guide. The light-extraction pixel can include a second layer of a reflective mirror material coupled to a second surface of the first layer of the reflective ink material. The reflective mirror material configured to reflect light orthogonal to the first surface of the first layer of the reflective ink material.

In some implementations, the second layer of the reflective mirror material is selectively deposited on the first layer of the reflective mirror material using selective vacuum metal deposition. In some implementations, the first layer of the reflective ink material is cured using ultra-violet light.

At least one other aspect of the present disclosure is directed to a solar-powered sign. The solar-powered sign can include a light guide. The light guide can include a sheet of at least partially transparent material configured to transmit light. The light guide can include a plurality of light-extraction features formed on a surface of the sheet. Each light-extraction feature of the plurality of light-extraction features comprises a reflective mirror layer deposited on a surface of the light-extraction feature. The solar-powered sign can include a diffusion film coupled to the light guide. The solar-powered sign can include a solar panel coupled to the light guide that captures light passing through the diffusion film and the light guide.

In some implementations, at least one surface of the solar-powered sign is a printable surface. In some implementations, the plurality of light-extraction features is deposited in a predetermined pattern across the surface of the sheet. In some implementations, the solar-powered sign includes a battery electrically coupled to the solar panel.

In some implementations, the solar-powered sign includes power circuitry configured to charge the battery using energy generated by the solar panel. In some implementations, the solar-powered sign includes a light source coupled optically coupled to the light guide, the light source configured to illuminate the solar-powered sign via the diffusion film. In some implementations, the solar-powered sign includes a printed overlay film.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. It will be readily appreciated that features described in the context of one aspect of the invention can be combined with other aspects. Aspects can be implemented or combined in any convenient form.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 depicts a side profile view of an individual pixel with the average dimensions of a printed pixel, in accordance with one or more implementations;

FIG. 2 depicts an example pixel pattern generated based on a pseudorandom Poisson disk sampling algorithm, in accordance with one or more implementations;

FIG. 3 depicts example ultra-violet (UV) ink pixel patterns on a printed light guide plate, in accordance with one or more implementations; and

FIG. 4 depicts an example of a light guide plate including light emitting diode (LED) light-injection cutouts, an LED mixing area, and a display surface, in accordance with one or more implementations.

### DETAILED DESCRIPTION

Edge-lit light guide plates can be utilized to implement thin, uniform lighting. Use cases include liquid crystal display (LCD) backlighting, image backlighting, and outdoor signage lighting. These use cases benefit from efficient light-extraction techniques when implementing robust and uniform illumination. Various light-extraction techniques can be utilized in with light guide plates to achieve efficient light-extraction, including surface etching, embedding particles in the light guide plate, and surface-printed patterns. However, these methods have drawbacks that trade light-extraction efficiency for ease of production.

Light guide plates used in solar signage suffer additional drawbacks, in that the light-extraction techniques preferably have a minimal effect on the ability of external light to “pass through” the plate to the solar panel backing. The external pass-through efficiency can be inversely related to the light-extraction efficiency, especially in the case of surface-printed patterns, where the surface area covered by the pattern blocks some pass-through. Additionally, the dark-colored backing solar panel absorbs some of the edge-injected light, reducing the light extraction efficiency further.

The light guide plates described provide increased light extraction efficiency without sacrificing sunlight pass-through efficiency to a backing solar panel. The present techniques provide light guides that include printed pixels, which can be selectively coated with a thin layer of a reflective substance. The reflective coating results in concave mirrors that direct the edge-injected light orthogonally to the surface of the light guide plate. Because this does not increase the overall surface area of the pixel coverage, this has a minimal effect on the transmission of external sunlight to the backing solar panel, allowing significant pass-through, while increasing the efficiency of injected light extraction.

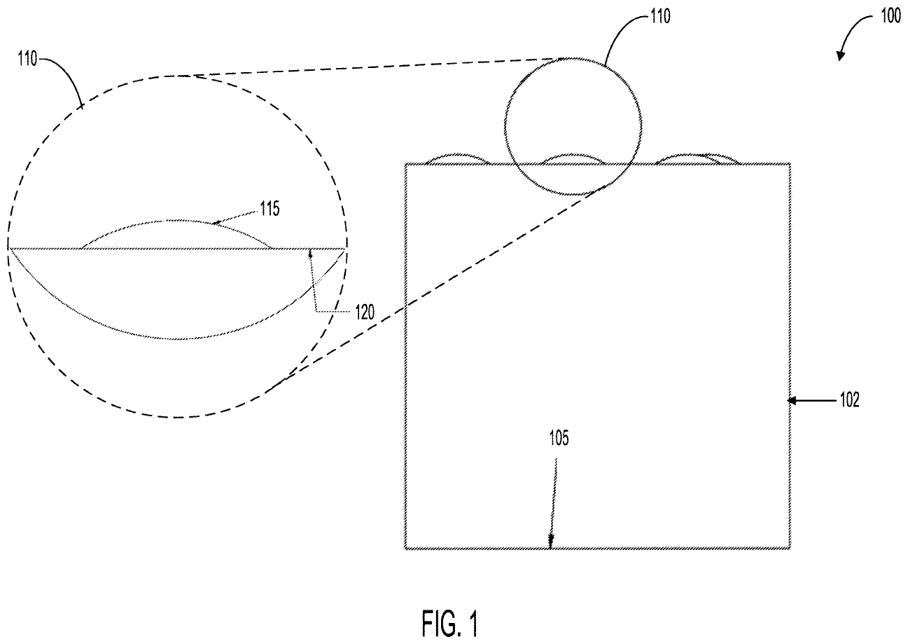

Referring to FIG. 1, depicted is a side cross-sectional view of a light guide 100 and a zoomed view 110 of an individual pixel 115 on a back surface 120 of the light guide 100, in accordance with one or more implementations. Additionally, FIG. 1 shows a close-up view 110 of the pixel 115 on the back surface 120. The light guide 100 can be a transparent plate of material that can both receive and guide light from one or more light sources. For example, the light guide 100 can be made from acrylic, polycarbonate, or another type of plastic or translucent material. As shown, the light guide 100 can receive light from a light source (e.g., light-emitting diodes) along the edge 102. Additionally, the light guide 100 can receive light from an external light source, such as the sun, along the front surface 105. The light guide 100 can include one or more light extraction features, such as the pixels 115. The surface of the light guide 100 can include several light extraction features distributed across the back surface 120. The pixels 115 can extract a portion of the light injected into the light guide 100, such as the light emitted by the light sources as described herein. The pixels 115 can be distributed across the surface of the light guide 100 in a predetermined pattern, such that light is uniformly extracted, and thus emitted, across the entire surface of the light guide 100.

The light guide 100 can be manufactured in any suitable shape, such as a thin, rectangular plate for signage applications. The light guide plate 100 can vary in lateral dimensions, ranging from a few inches to several feet depending on the type of application. The thickness of the light guide plate 100 can also vary for the desired illumination (sometimes referred to as “throw”) over the entire lateral distance of the light guide 100. The light guide plate 100 can have a uniform thickness. The pixels 115 can be formed on the light guide 100 using a printing process. For example, the pixels 115 can be formed using an inkjet printer, such as an industrial flatbed inkjet printer. The pixels 115 can be printed on the back surface 120 of the light guide material in a predetermined ink color, such as a white ink that reflects light. After printing, the pixels 115 can be cured using UV light. The pixels 115 can vary in dimensions. In the example shown, the pixels can have an average diameter of 170 μm, and an average height of 25 μm.

The pixels 115 can then be selectively coated with a layer of a metal (e.g., aluminum, other reflective metals, etc.) using a selective vacuum metal deposition technique. This can create a small concave mirror over each pixel 115. The layer of metal can have a predetermined thickness, which may vary by application. For example purposes, this layer of metal can be 400 angstroms thick. The layer of metal formed over the pixels 115 directs light traveling through the light guide 100 out of the front surface orthogonally, or at an angle approaching an orthogonal. The perceived brightness of the light guide 100 is increased by the metal layer because less light leaves the guide at a sharp angle in a direction where the viewer cannot generally see the illuminated display. Instead, the light is reflected orthogonally from the surface 105, thereby increasing the amount of light directed outward to viewers of the light guide plate 100 (e.g., when installed in a solar sign).

To form the metal layer on the pixels 115, a metal deposition process can be performed. The metal deposition process can be a wet metal deposition process or a dry metal deposition process. The wet metal deposition process can begin by printing a predetermined pattern (e.g., the pattern for the pixels 115) on a predetermined region of the light guide 100, for example, using an inkjet printer. Then, a vacuum-based deposition process can be applied to deposit a layer of a metal (e.g., aluminum, titanium, platinum, silver, another type of reflective metal, etc.) over the light guide. A selective subtractive process (e.g., application of a wet-etchant, etc.) can then be applied to remove the layer of the metal in the areas between the pixels 115, leaving a layer of the metal coating over each of the pixels 115. This process can therefore be used to selectively form the metal mirror-like layer over each of the pixels 115, which greatly increases the apparent brightness of the light guide 100.

Alternative selective deposition techniques may also be applied. For example, one approach may involve a dry selective deposition process. In a dry selective deposition process, a portion of the light guide 100 can first be subjected to a chemical formula that will lower the surface energy of the portion of the light guide 100. For example, the light guide 100 can be exposed to fluorocarbon (e.g., CF₄, etc.), which can alter the surface energy of the light guide 100. The fluorocarbon can be provided in a vapor deposition process. The altered surface energy can both resist the deposition of metal material, and can cause the printed ink deposited using the printing process to form “bubble” like shapes, thereby creating pixels 115 with more consistent shape that is optimal for the light guide 100 functionality. After performing the printing process to deposit the ink for the pixels 115, a curing process (e.g., a UV curing process) can be performed, followed by a metallization process that selectively deposits metal on the pixels 115. Because the surface energy of the regions of the light guide 100 has been changed, the metal does not adhere to the light guide 100, but does adhere to the pixels 115, creating the metalized layer.

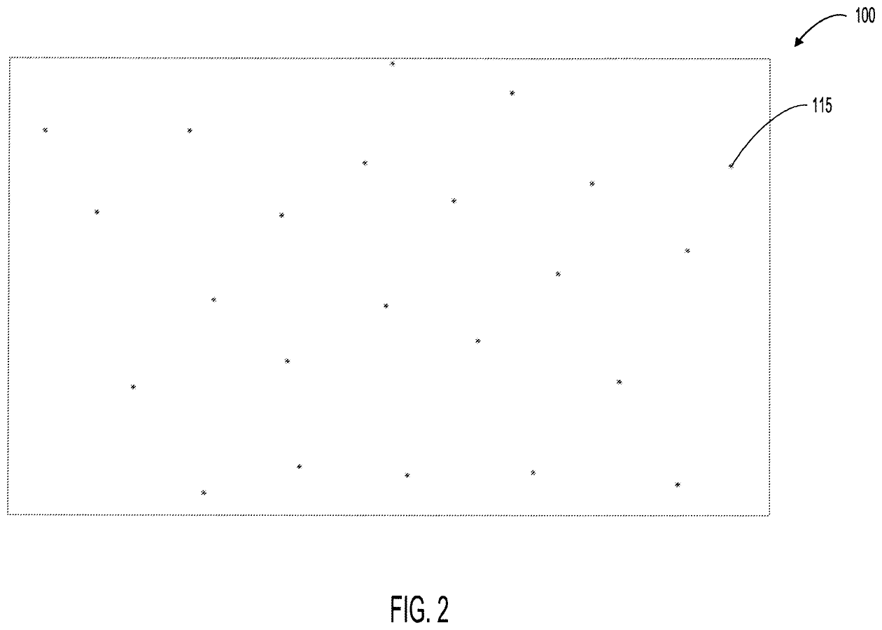

An example distribution of the pixels 115 is shown in FIG. 2. Referring to FIG. 2, depicted is a front view of the light guide plate 100 of FIG. 1 with an example pattern of pixels 115 generated based on a pseudorandom Poisson disk sampling algorithm, in accordance with one or more implementations. The spaces between pixels 115 can be enforced in a gradient. The gradient can be configurable, and can range, for example, from 0.65 mm to 0.10 mm across the light guide 100 proportionally to the distance from the light injection edge. However, it should be understood that these are purely example values, and the pixels 115 may be separated using different rules. For example, alternative algorithms may also be used to distribute the pixels 115 to achieve uniform illumination.

The pseudorandom Poisson disk sampling algorithm can prevent moiré effects, which would result in visible dots, lines or structures when viewed from a distance. Examples of the resulting pixel 115 placements using these techniques algorithm are shown in FIG. 2. The separation gradient can ensure even lighting across the light guide 100, accounting for the brightness drop-off as injected light from a first edge of the light guide 100 travels the length of the light guide to a second edge. Additionally, a short (e.g., 1-inch, 0.5 inches, other distances) “mixing area” can be provided between the light injection point and the beginning of the print, which prevents blooming effects from the individual LEDs. These combined effects ensure uniform brightness in both the large-scale and small-scale patterns of the light guide plate.

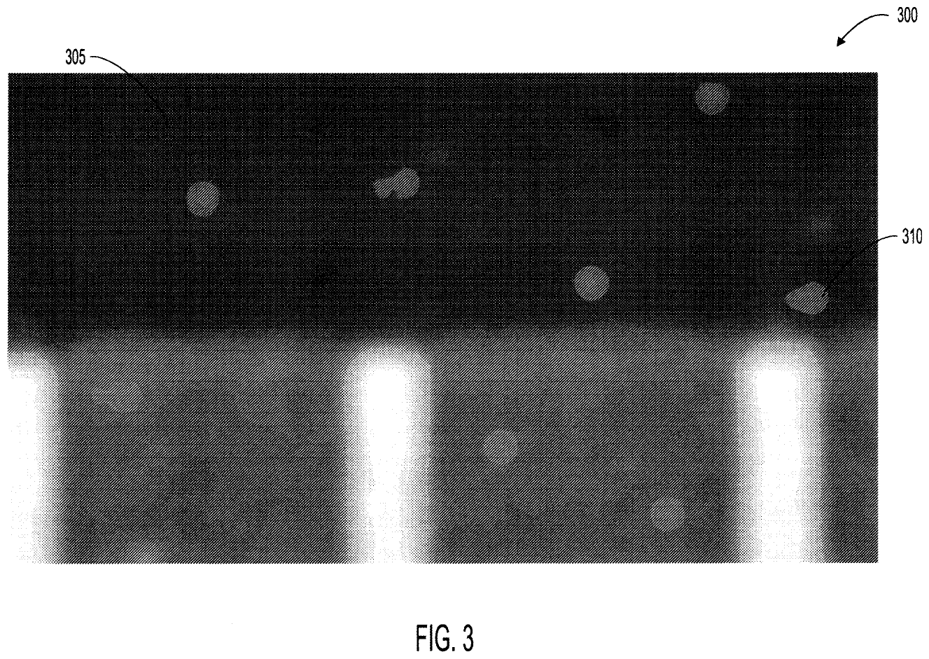

An example distribution of pixels 310 printed on an example light guide 305 is depicted in the photograph 300 shown in FIG. 3. Referring to FIG. 3, depicted is a photograph 300 of an example ultra-violet (UV) ink pixels 310 on a printed light guide plate 305, in accordance with one or more implementations. The light guide 305 can be similar in structure and function to the light guide 100 described in connection with FIG. 1, and the pixels 310 can be similar in structure and function to the pixels 115 described in connection with FIG. 1. As shown, the pixels 310 are generally uniform and separated from one another by varying distances. The pixels 310 are shown as having generally the same shape and size, and are distributed relatively evenly, although randomly, across the surface of the light guide 305. This is consistent with the example representation of the Poisson disk sampling distribution described in connection with FIG. 2. The gradient spacing between the pixels 310 ensure uniform brightness in both the large-scale and small-scale patterns of the light guide plate.

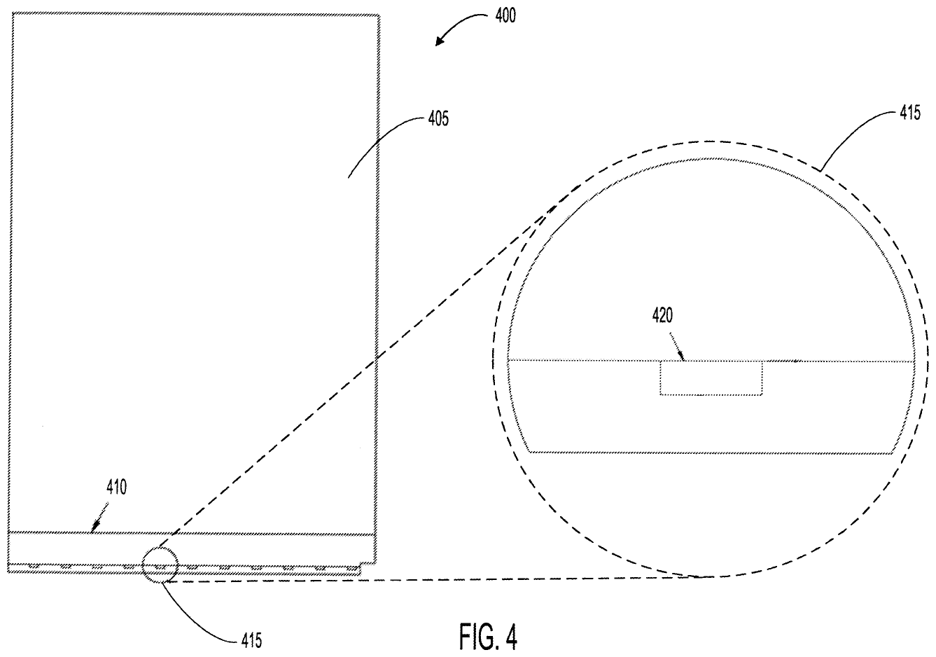

Referring to FIG. 4, and others, depicted is a side view an example light guide plate 400 including LED light-injection cutouts 420, an LED mixing area 410, and a display surface 405, in accordance with one or more implementations. The light guide plate 400 can be similar in structure to the light guide 100 described in connection with FIG. 1, and As shown in the zoomed view 415, the light-injection cutouts 420 allow for light to be injected into the 420 light mixing area of the light guide plate 400. The light mixing area is a region of the light guide 400 that does not include any pixels (e.g., the pixels 115). The light mixing area is provided between the light injection point and the beginning of the print, which prevents blooming effects from the individual LEDs. The light mixing area can be relatively small when compared to the display area, and can be, for example, about 1-inch in thickness from the LED injection point to the region of the light guide 400 that includes pixels (e.g., the display surface 405).

The light guide 400 can be optically coupled to light sources, such as LEDs, which can uniformly illuminate the light guide 400. The light sources can be positioned within cutouts 420. The cutouts 420 can be formed in the light guide 400. Each light source can emit light through the cutout, and into the edge of the light guide 400. In some implementations, the cutouts 420 are formed in an adjacent material that is coupled to the edge of the light guide 400. Light from the light sources is injected (e.g., emitted) into the body of the light guide 400, traveling through the mixing area 410 and into the display surface 405. In some implementations, the light guide 400 is can be a uniform rectangular plate that can receive light emitted from the light source via an edge of the light guide 400. In such implementations, the light sources can be positioned external to the light guide 400 and inject light into the light guide plate via the edge, rather than being positioned in the cutouts 420.

The light guide plate 400 can assembled into a solar sign comprising of an outer frame, an internal solar panel behind the light guide plate, a diffusion and art layer over the display surface 405 of the plate, and an LED strip with accompanying battery and electronics that drive power collection and illumination. Some example components that may be utilized in such solar signs can include a housing, the light guide plate 400, a solar panel, one or more printed circuit boards (PCB) comprising electronic components such as power distribution circuitry and processing components (e.g., a processor, memory, one or more microcontrollers, etc.), various layers of diffusion film, LED light sources or other light sources, one or more batteries to store electric power generated by the solar panel, and spacer materials that fill space within the solar sign between components, among others. The layers in the solar sign can be stacked and coupled to one another, for example, using an adhesive or mechanical coupling or connector. In some implementations, the layers can be coupled to one another via mechanical force.

The housing of the solar sign can be a waterproof and weatherproof container that contains each of the layers described above. The housing can prevent unwanted materials (e.g., water, dust, debris, etc.) from entering the sign and causing electrical issues or blocking light paths. The housing can be constructed from a polymer material, a metal material, or a composite material. Each of the components of the solar sign described above can be positioned in or coupled to the housing, for example, in one or more layers of a stack. The components can be coupled to one another, for example, by one or more mechanical features (e.g., each of the components can be manufactured to fit together tightly within the housing, etc.), such as connectors, fasteners, or other mechanical coupling features. One or more of the components of the solar sign can be coupled to one another via an adhesive or other non-mechanical coupling agent. In some implementations, the adhesive can be an optically transparent adhesive. The outer portion of the housing can be coupled to the supporting hardware, such as an A-frame, to mount the sign on one or more surfaces. The housing can include one or more connectors to couple to other solar signs or other support features.

The one or more batteries can be a thin, flat battery that can provide electrical power to one or more of the electronic components of the solar sign, such as the electronic components on the PCB and the LED light sources that illuminate the solar sign via the light guide 400. The one or more batteries can include one or more re-chargeable batteries, such as lithium-ion batteries, lithium-polymer batteries, nickel-cadmium batteries, or other types of high-density re-chargeable batteries with thin form factors. The one or more batteries can receive electric power from the solar panel, for example, via charging circuitry present on the PCB of the solar sign. The one or more batteries can discharge electrical energy through one or more light sources, such as light-emitting diodes, that are present in the solar sign. The one or more batteries can be positioned in the solar sign such that it is easily removable. In some implementations, the components of the solar sign can fit together such that the solar sign can be disassembled, and the one or more batteries can be replaced.

The layers of diffusion film can each include a sheet of partially transparent film that has a first surface coupled to the light guide plate 400 or a spacer layer (e.g., which can be a transparent plastic spacer, for example, to achieve a desired structural thickness, etc.). The layers of diffusion film can each be a partially transparent film that appears white, or another solid color, while still allowing an amount of light to pass through the diffusion film and into the light guide 400. For example, light emitted by an external light source (e.g., the sun, etc.) can pass through the diffusion film and the light guide 400, striking the solar panel where it is absorbed. The diffusion film can be uniformly illuminated by the light extracted by the pixels 115 described in FIG. 1 of light guide 400, such that the solar sign and any graphical designs printed thereon can be illuminated in low-light environments (e.g., at night time, etc.). The diffusion film can have, for example, greater than 70% angular diffusion. The diffusion film can have a light transmission rate that exceeds 80%. In some implementations, the diffusion film can have a rough surface, and thus when coupled to the light guide 400, the majority of the surface of the light guide 400 is exposed directly to air, because the rough surface of the diffusion film is not uniform or perfectly flat.

The solar panel can be coupled to one or more batteries and the light guide 400, and can absorb light that passes through one or more layers of diffusion film and the light guide 400. The solar panel can provide electric power to the other components of the solar sign, for example, by storing generated electrical energy in the one or more batteries. Light emitted from an external light source (e.g., the sun, etc.) can pass through the layers of the diffusion film and the light guide 400 and contact the surface of the solar panel. Photons in the light can be absorbed by the solar panel and converted into an electron flow that is stored in the one or more batteries (e.g., via power circuitry on the PCB of the solar sign, etc.). The one or more batteries can store a charge over the course of a day (e.g., via the solar panel absorbing energy from an external light source, etc.). Then, in circumstances of low light (e.g., each evening if the solar sign is positioned outside, etc.), the solar panel can generate a decreased electron flow (e.g., a decreased voltage from what was produced during periods of high external light, etc.) The solar panel can be any sort of photovoltaic cell or photovoltaic film having a thin form factor. The solar panel can be constructed from semiconducting materials, such as doped silicon.

The PCB can include or can be electrically coupled to the one or more light sources, the one or more batteries, and the solar panel. The PCB can provide energy to the light sources, which can illuminate the solar sign via the light guide 400. The light sources can be any sort of light source that can emit light in response to receiving electric energy. The light sources can be electrically coupled to and receive electric power from the one or more battery, for example, via power circuitry (e.g., voltage converters, etc.) on the PCB. The light sources can emit light with an intensity that is proportional to the amount of electric power received from the power circuitry. Control circuitry (e.g., a processor, microcontroller, etc.) can vary the intensity of the light sources according to a configurable duty cycle. The duty cycle may be varied, for example, according to a level of ambient light detected using a light sensor of the solar sign (e.g., an external light sensor, the solar panel, etc.). The power circuitry can control the amount of electric power provided to the light sources, and thus the amount of light emitted by the light sources. The light sources can have a thickness that corresponds (e.g., about equal to, less than, etc.) to a thickness of the light guide 400. The light sources can sit in the cutouts 420, and inject light into the mixing area 410 of the light guide 400. The light sources can be, for example, one or more LEDs or any other type of light source. The light source can be a bright source of light that uses a low amount of power.

The solar sign can include a printable surface, on which designs or other graphical features can be printed. The printable surface of the solar sign can be formed from a layer of diffusion film, and can therefore include any of the functional or structural features of the diffusion film described herein above. The top printable surface can include a light-turning imprinted surface (e.g., the surface facing the external environment, etc.). The printable surface can include a partially transparent surface that appears white, or another solid color, while still allowing an amount of light to pass through the diffusion film and into the light guide 400. Light from an external light source (e.g., the sun, etc.) can pass through the printable surface and the light guide 400, striking the solar panel described above, where it is absorbed. The printable surface can be a printable film. The printable surface can be made from a material to which printer ink can be directly applied. Thus, in some implementations, the solar sign can be passed through a printer, such as an inkjet printer, which can print ink directly onto the printable surface of the solar sign. The solar sign can be placed on or coupled to a template that guides the solar sign through the printer to facilitate the printing process.

The printable surface can be printed on using a latex ink, a colored latex ink, a black ink, a white ink, or any other semi-transparent ink. The printable surface can be uniformly illuminated by the light extracted by the light extraction features of the printable surface, such that the solar sign and any graphical designs printed thereon can be illuminated in low-light environments (e.g., at night time, etc.). In some implementations, and as described herein above, the printable surface can be coupled to an overlay film such that the illuminated printable surface provides uniform illumination through the overlay film. In some implementations, the printable surface can be easily removable and replaceable. Thus, different designs for the solar sign can easily be changed by exchanging the printable surface having different designs printed thereon.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. For example, a reference to “at least one of ‘A’ and ‘B’” can include only “A,” only “B,” as well as both “A” and “B.” Such references used in conjunction with “comprising” or other open terminology can include additional items.

Where technical features in the drawings, detailed description or any claims are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, and orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein can be embodied in other specific forms without departing from the characteristics thereof. Scope of the systems and methods described herein is thus indicated by the appended claims, rather than the foregoing description, and changes that come within the meaning and range of equivalency of the claims are embraced therein.

While this specification contains many specific implementation details, these should not be construed as limitations on the scope of any inventions or of what can be claimed, but rather as descriptions of features specific to particular embodiments of particular aspects. Certain features described in this specification in the context of separate embodiments can also be implemented in combination in a single embodiment. Conversely, various features described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated in a single software product or packaged into multiple software products.

Thus, particular embodiments of the subject matter have been described. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A light guide, comprising:
a sheet of at least partially transparent material configured to transmit light; and
a plurality of light-extraction features formed on a surface of the sheet, each light-extraction feature of the plurality of light-extraction features comprises a reflective mirror layer deposited on a surface of the light-extraction feature.

2. The light guide of claim 1, wherein the plurality of light-extraction features are deposited in a predetermined pattern across the surface of the sheet.

3. The light guide of claim 2, wherein the predetermined pattern is generated using a pseudorandom sampling algorithm.

4. The light guide of claim 1, wherein the plurality of light-extraction features are deposited on the sheet using an inkjet printing process.

5. The light guide of claim 1, wherein the plurality of light-extraction features comprise a white ink.

6. The light guide of claim 1, further comprising a cutout on an edge of the sheet.

7. The light guide of claim 6, further comprising a light source positioned within the cutout, the light source configured to inject light into the edge of the sheet to illuminate the surface of the light guide via the plurality of light-extraction features.

8. The light guide of claim 1, wherein the sheet comprises a polycarbonate material or an acrylic material.

9. The light guide of claim 1, wherein the plurality of light-extraction features are configured to receive light from an edge of the sheet, and reflect the light to illuminate a diffusion film coupled to a second surface of the light guide.

10. The light guide of claim 1, wherein the sheet comprises a region of a predetermined size that does not include the plurality of light-extraction features.

11. A light-extraction pixel, comprising:
a first layer of a reflective ink material having a first surface configured to couple to a light guide; and
a second layer of a reflective mirror material coupled to a second surface of the first layer of the reflective ink material, the reflective mirror material configured to reflect light orthogonal to the first surface of the first layer of the reflective ink material.

12. The light-extraction pixel of claim 11, wherein the second layer of the reflective mirror material is selectively deposited on the first layer of the reflective mirror material using selective vacuum metal deposition.

13. The light-extraction pixel of claim 11, wherein the first layer of the reflective ink material is cured using ultra-violet light.

14. A solar-powered sign, comprising:
a light guide, comprising:
a sheet of at least partially transparent material configured to transmit light; and
a plurality of light-extraction features formed on a surface of the sheet, each light-extraction feature of the plurality of light-extraction features comprises a reflective mirror layer deposited on a surface of the light-extraction feature;
a diffusion film coupled to the light guide; and
a solar panel coupled to the light guide that captures light passing through the diffusion film and the light guide.

15. The solar-powered sign of claim 14, wherein at least one surface of the solar-powered sign is a printable surface.

16. The solar-powered sign of claim 14, wherein the plurality of light-extraction features are deposited in a predetermined pattern across the surface of the sheet.

17. The solar-powered sign of claim 14, further comprising a battery electrically coupled to the solar panel.

18. The solar-powered sign of claim 17, further comprising power circuitry configured to charge the battery using energy generated by the solar panel.

19. The solar-powered sign of claim 14, further comprising a light source coupled optically coupled to the light guide, the light source configured to illuminate the solar-powered sign via the diffusion film.

20. The solar-powered sign of claim 14, further comprising a printed overlay film.
